(19) United States
(12) Patent Application Publication
(10) Pub. No.: US 2002/0096610 A1
(43) Pub. Date: Jul. 25, 2002

(54) Support for advertising or publicity posters

(76) Inventor: Luciano Hinojosa Fernandez, Barcelona (ES)

Correspondence Address: BRINKS HOFER GILSON & LIONE, P.O. Box 10395, Chicago, IL, 60610, US

(21) Appl. No.: 10/057,320

(22) Filed: Jan. 24, 2002

(30) Foreign Application Priority Data
Jan. 24, 2001 (ES) U200100170

(51) Int. Cl. A47K 1/00; E04G 3/00; F21V 21/00

(52) U.S. Cl. 248/218.4; 248/223.41; 248/227.3; 248/230.5

(57) ABSTRACT

Conceived to be place on a post, for instance that of a street-lamp, this support is constituted by two semi-clamps (1) and (2), which include various radial flanges (4-4′), those of one of the semi-clamps being equipped with toothed strips (5), and those of the other with grooves (6) with a complementary tooth, in such a way that the clamp closes by mere pressure of one semi-clamp on the other with the interposition of the post. Additionally, each semi-clamp includes a prismatic-rectangular housing (9), open at the top and sideways by means of an intermediate groove (10), where a prismatic-rectangular head (11) is capable of being plugged, said prismatic-rectangular head (11) finishing off each arm (12) sustaining the advertising publicity poster, and being perfectly stabilized in the housing (9) while the arm (12) emerges outwards through the groove (10).

### DESCRIPTION

### OBJECT OF THE INVENTION

The present invention refers to a support that has been especially conceived for sustaining advertising or publicity posters, of the “flag” type, that are generally placed at a considerable height on a post, street-lamppost or other similar element.

The object of the invention is to obtain a support that is highly resistant to weather effects, quick and easy to place on the corresponding post or the like, that also permits an unmoveable assembly of the publicity posters on the actual support, with the consequent versatility this involves.

### BACKGROUND OF THE INVENTION

One of the normal forms of establishing advertising or publicity posters in public thoroughfares consists, for example, in using to this effect lighting street-lamps, in such a way, that at an appropriate height of the post of said street-lamps, a horizontal arm is attached, from which the poster is suspended in the manner of a flag.

In practice, metallic clamps are used, which on occasions, are attached by means of screwing to the lamppost, with the consequent deterioration of the same, and which in a more common way, are attached by simple pressure, by means of screws relating the two semi-clamps or parts of the clamp. In addition to this clamp, at least one arm is made to form integral part that is intended for lateral or radial projection from the lamppost, the advertising or publicity posters being suspended from this arm.

This type of support presents wide and varied problems that can be summarized as follows:

In spite of being suitably treated, for example, by means of a galvanic coating, environmental inclemency causes due to its metallic nature, a rapid deterioration of the clamp, which a long time before being destroyed, generates a deplorable aesthetic appearance in the support, that extends to the actual post of the street-lamp when the residues generated in the oxidation of the support propagates along the same.

Its assembly on the street lamppost is quite slow, and can be calculated to be of approximately fifteen minutes, and since it is located, due to obvious reasons of publicity, generally in zones of considerable road traffic, both the assembly and the subsequent maintenance tasks involve an interruption of said road traffic generating important circulation problems.

The arms are rigidly joined to the clamp, in such a way, that the existence of supports with one or two arms, depending on its specific application, is mandatory. This makes both the manufacturing cost and the storage cost more expensive.

The actual one-piece union between arms and clamp also determines the need for different supports for posters with different widths.

On windy days, the visualization of the poster is very difficult, losing the greater part of its efficacy due to the tendency to swing and to its wrapping around the actual arm of the support.

### DESCRIPTION OF THE INVENTION

The support for advertising or publicity posters proposed by the invention solves the previously indicated problems in a totally satisfactory manner in all and each one of the different aspects expressed.

For this and more specifically, said support, centres its characteristics on the following aspects, as from the basic structurisation of a conventional support of the type previously indicated, in which a rigidizing clamp participates on the corresponding post and one or more lateral arms for sustaining the respective posters:

The clamp is constituted by means of the combination of two recyclable plastic parts, with an appropriate colour that does not negatively influence the environment and is suitably treated versus ultraviolet rays to prevent is degradation.

The two parts constituting the clamp are provided with the following: one of them with two lateral grooves, internally toothed and the other with two strips, likewise toothed and of considerable length, in such a way, that the locking of the clamp is performed by simple thrusting on said strips in the recess of the complementary grooves, which permits an extremely rapid and safe assembly, at the same time also permitting the attachment of the support to posts with different diameters.

Each one of the two parts that make up the clamp, or at least one of them, externally includes one hollow protuberance, open at the top and externally grooved, that permits the male-female coupling, with a perfect fit, with an expanded head finished off with the corresponding arm sustaining the poster, in such a manner, that said arms are physically independent from the clamp, and can be assembled on the latter once it has been attached to the post.

Each sustaining arm of the corresponding poster is capable of including a plastic web for the inclusion of the latter, that prevents its swinging, attaching said poster to the arm by means of a pair of attachment clips.

### DESCRIPTION OF THE DRAWINGS

Complementary to the description being made, and with the purpose of aiding a better understanding of the characteristics of the invention, according to a preferred practical exemplary embodiment of the same, this description is enclosed, forming integral part of the same, with a set of drawings in which, with illustrative and non limitative character, the following has been represented:

FIG. 1 shows a perspective breakdown of a support for advertising or publicity posters carried out according to the object of the present invention, jointly with a post on which it is intended to be attached.

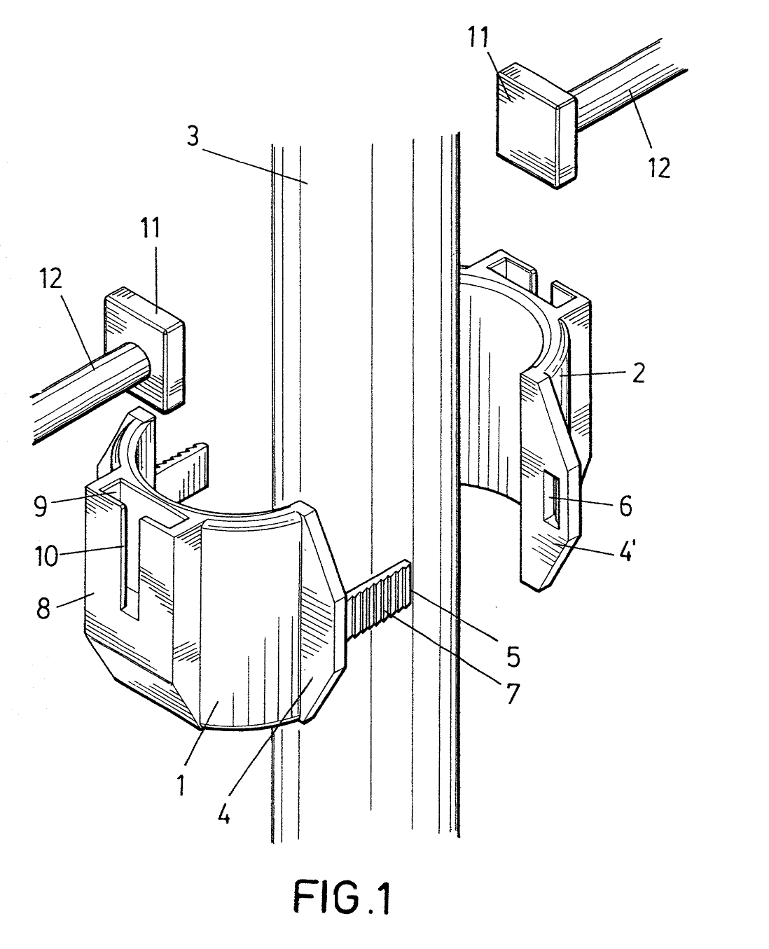

FIG. 2 shows, also according to a perspective view, the same assembly of the previous figure, appropriately mounted, on which a sectional detail at the same level as one of the attachment points between the two semi-grips has been represented.

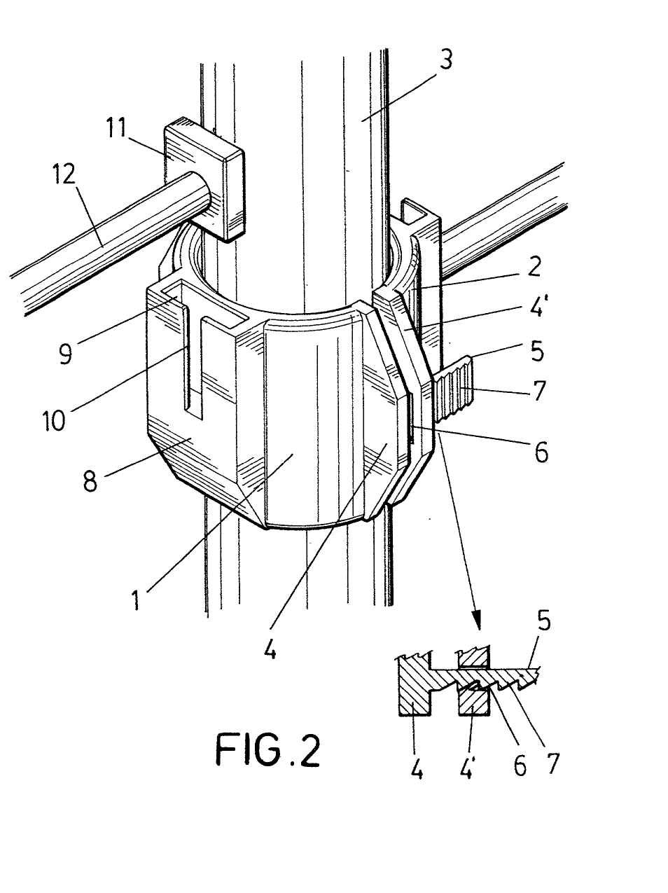

FIG. 3 finally shows the support of the invention appropriately coupled onto a streetlamp and attaching two advertising or publicity posters, also according to a perspective view.

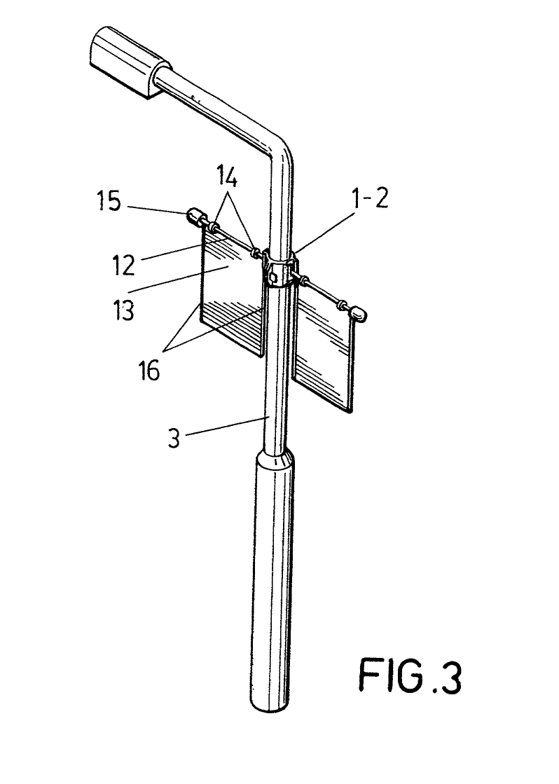

### PREFERRED EMBODIMENT OF THE INVENTION

In view of the indicated figures, it can be observed how the proposed support is constituted by two semi-clamps (1-2), of plastic nature, each one of which presents a concave surface, tending towards a semi-cylinder, to be correctly adapted to the corresponding sustaining post (3), as for example a street-lamppost. These semi-clamps (1-2) include at their confronted edges, various radial flanges (4-4′), one of them being equipped, as a perpendicular extension of the same, with a strip (5) forming integral part with the same, and the other with a groove (6), these elements, strip (5) and groove (6) being provided with complementary teeth (7), with saw-tooth profile, that aids the penetration of strips (5) inside grooves (6) but that make impossible their subsequent extraction, which in turn permits an easy, rapid and safe assembly and traction of the clamp (1-2) on post (3)

Additionally, each one of the clamps (1-2) externally includes, a hollow protuberance (8), that determines the preferably prismatic-rectangular housing (9), open at the top and also open sideways by means of an intermediate groove (10) in such a way, that in this housing (9) is capable of being housed by “plugging”, the prismatic-rectangular head (11) that finishes off the internal end, corresponding to the arm (12) that sustains the advertising publicity poster (13) and that is attached to said arm (12) with the collaboration of clips (14), the free end of said arm (12) being finished off with a cap (15)

In accordance with this structure, not only are the clamps (1-2) easily couplable and attachable to the post (3), but also, on one or two arms (12) can be indistinctly assembled one same clamp (1-2), at the same time, said arms (12) can be of any length according to the requirements of posters (13) with different sizes.

Also, and for advantageously establishing said posters (13) suspended from arms (12), it has been provided that the latter may include a plastic web (16) constructed either on a laminar body housed inside a tubular poster, or on two parallel and vertical arms, housed in turn inside the tubular parts that are established at the side edges of the advertising and publicity poster, achieving in any case, that said poster remains perfectly extended and in an ideal vertical position for the visualisation of its contents.

1.- Support for advertising or publicity posters, that, being of the type intended to be attached to a post, as for example, a street-lamp, at an appropriate height, of the ones that include to this effect, a throttling clamp on said post from which one or two side sustaining arms for the corresponding posters emerge, is characterised in that said clamp is structured on the basis of two semi-clamps, made of treated plastic to resist weather effects, provided at their confronted edges with flanges orientated outwards, having provided that in the flanges of a semi-clamp, toothed strips have been established, that emerge perpendicular to the same, and that on the flanges of the other semi-clamp, grooves have been established, likewise toothed, that receive said strips, all this in such a manner, that due to a saw-toothed profile for said complementary teeth, the strips of one of the semi-clamps are capable of easy movement in the grooves of the other, in coupling direction, and of locking both semi-clamps on the post versus traction in the opposite direction.

2.- Support for advertising or publicity posters according to claim 1, characterised in that each one of the semi-clamps externally includes a projection in the middle of which a prismatic-rectangular housing is established, open at the top and in turn, open sideways by means of an intermediate groove in such a way, that each one of these housings is capable of coupling by plugging, a prismatic-rectangular head that finishes off the internal end of the corresponding support arm of the poster, said arm being finished off at its other end by a cap, all this so that on one same clamp one or two arms can be indistinctly assembled or sustaining one or two posters, and that arms with different lengths for posters of different widths, can be assembled on one same clamp.

3.- Support for advertising or publicity posters, according to the previous claims, characterised in that each arm includes a pair of clips for attaching the upper edge of the poster, and additionally, a plastic web, intended to be adapted to the poster or to house a plastic web in the hollow inside the same, rigidly joined to the corresponding arm to prevent the swinging of the advertising or publicity posters.
